(19) United States
(12) Patent Application Publication
(10) Pub. No.: US 2013/0259322 A1
(43) Pub. Date: Oct. 3, 2013

(54) System And Method For Iris Image Analysis

(71) Applicants: Xiao Lin, Indianapolis, IN (US); Zhi Zhou, Indianapolis, IN (US)

(72) Inventors: Xiao Lin, Indianapolis, IN (US); Zhi Zhou, Indianapolis, IN (US)

(21) Appl. No.: 13/436,889

(22) Filed: Mar. 31, 2012

(51) Int. Cl. G06K 9/62

(52) U.S. Cl. 382/117

(57) ABSTRACT

An iris recognition system incorporating two-level iris image quality assessment method is presented. Images with very low image quality may be assigned quality zero and not be further processed. Images with sufficient quality may be qualitatively assessed and each quality metric score may be calibrated. The calibrated quality scores may be fused to generate one quality score.

### TECHNICAL FIELD

The present invention pertains to recognition systems and particularly to biometric recognition systems. More particularly, the invention pertains to iris recognition systems.

### BACKGROUND

One reliable way to identify a person is to use human iris patterns. However, the quality of the iris image can affect the accuracy of the system. Failure to acquire, false rejection, and false acceptance are more likely to occur with poor quality iris images. These factors include out-of-focus, motion blur, image resolution, image contrast, iris occlusion, iris deformation, iris size, eye dilation, pupil shape, sharpness, eye diseases, and iris sensor (camera) quality. Methods have been used to evaluate the quality of an iris image. However, they often focus on only part of the factors.

### SUMMARY

This invention presents: 1) a comprehensive two-stage iris image quality measure method; 2) an iris recognition system implementing the presented two-stage iris image quality metrics for reliable iris recognition; and 3) an iris camera that incorporates iris image quality measure to acquire high quality images to improve iris recognition accuracy, efficiency, and usability. An overall iris image quality score and a set of individual iris image quality metric scores will be generated for an image with an iris. The overall image quality score predicts iris recognition accuracy using the image.

### BRIEF DESCRIPTION OF THE DRAWINGS

FIG. 1 is a diagram of an iris recognition system incorporating one global iris image quality measure module and one preprocessing and quantitative iris image quality measure module;

FIG. 2 is a diagram of the global iris image quality measure module;

FIG. 3 is a diagram of the preprocessing and quantitative iris image quality measure module;

FIG. 4 is a diagram of a video-based iris recognition system incorporating one video-based global iris image quality measure module and one preprocessing and quantitative iris image quality measure module;

FIG. 5 is a diagram of the video-based global iris image quality measure module;

FIG. 6 is a diagram of an enrollment data committed iris recognition system incorporating one global iris image quality measure module and one enrollment data committed preprocessing and quantitative iris image quality measure module;

FIG. 7 is a diagram of the enrollment data committed preprocessing and quantitative iris image quality measure module;

FIG. 8 is a diagram of an enrollment data committed video-based iris recognition system incorporating one video-based global iris image quality measure module and one enrollment data committed preprocessing and quantitative iris image quality measure module;

FIG. 9 is a diagram of an iris image quality assurance camera that incorporates the global video-based iris image quality measure;

FIG. 10 is a diagram of an iris recognition system incorporating the iris image quality assurance camera.

FIG. 11 is a diagram of an enrollment data committed iris image quality assurance camera that incorporates a two-stage iris image quality measure;

FIG. 12 is a diagram of an enrollment data committed iris recognition system incorporating the enrollment data committed iris image quality assurance camera.

FIG. 13 shows an example of valid eye area.

### DETAILED DESCRIPTION

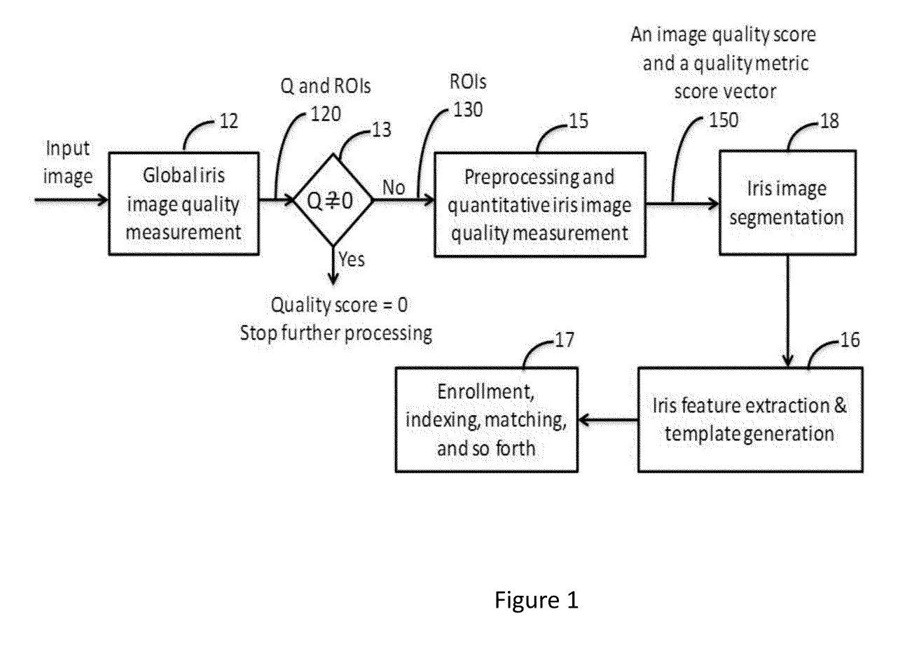

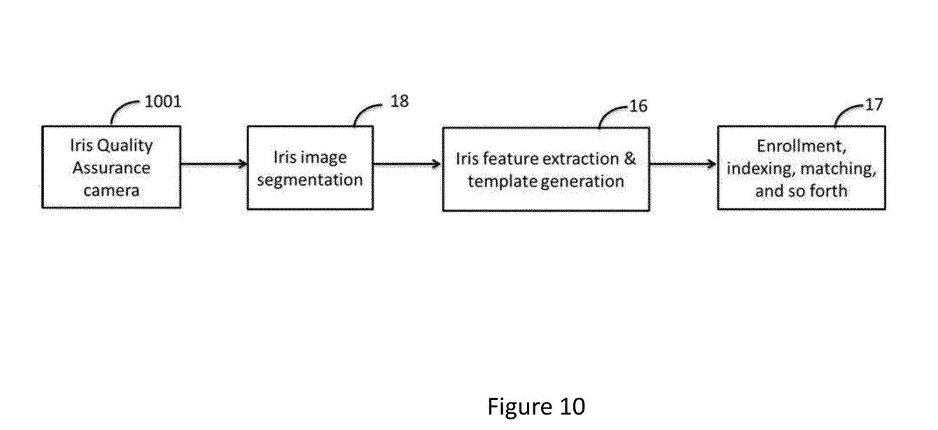

The present system and method may relate to biometrics, iris recognition systems, image quality metrics, and iris camera. The present system (FIG. 1) addresses two-stage iris image quality measure procedures (the global iris image quality measure module 12 and the preprocessing and quantitative iris image quality measure module 15) that may be included prior to iris recognition. The two-stage iris image quality measure modules can be incorporated into an iris camera and provide iris image quality assurance in the iris image acquisition step (FIG. 10).

The objective of the present invention is to separate iris image quality measures into two stages to improve quality assessment efficiency, provide comprehensive and quantitative image quality evaluation, and predict iris recognition accuracy based on the generated iris image quality score.

The present invention can be used to assess an iris image quality, an iris video image quality, an individual iris image quality with known enrolled iris data characteristics, and an iris video image quality with known enrolled iris data characteristics.

The present invention can be incorporated into an iris camera to produce an iris image quality assurance camera and an enrollment data committed iris image quality assurance camera with known enrolled iris data.

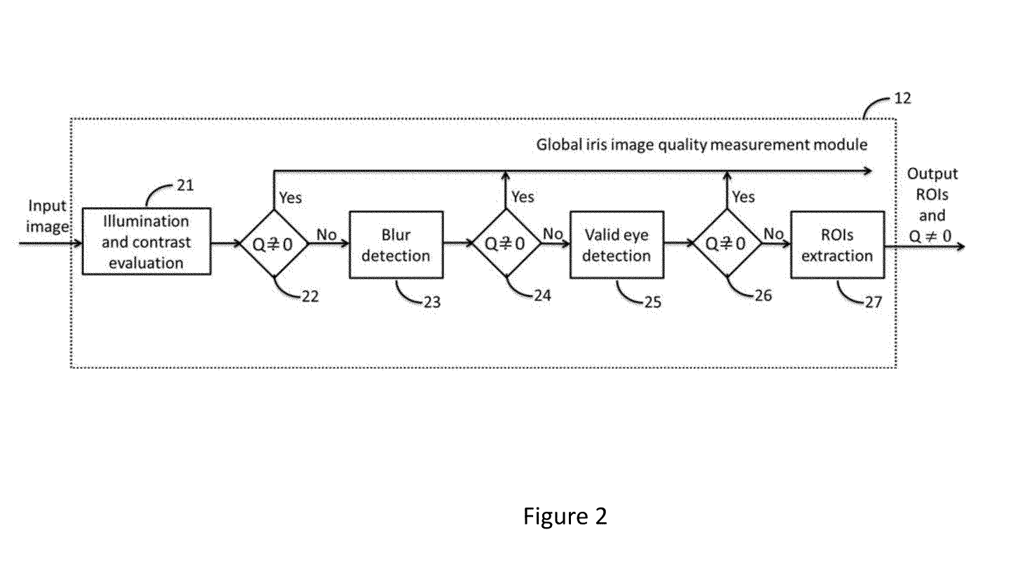

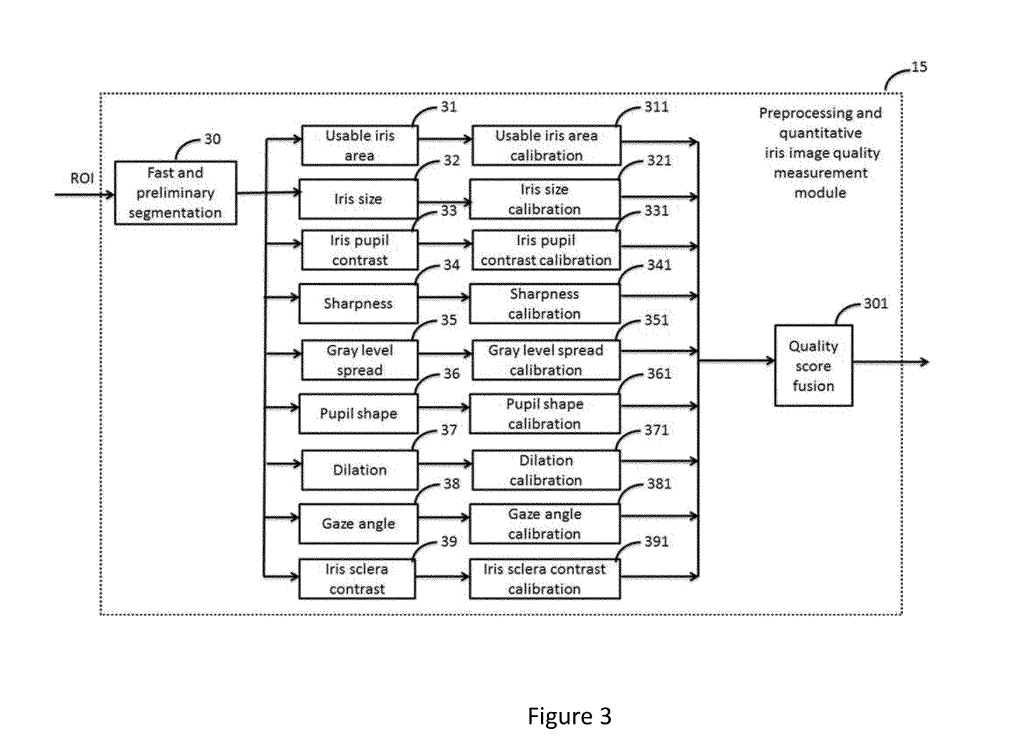

An individual image-based iris recognition system is shown in FIG. 1. It shows an image is first sent to the global iris image quality measure (block 12) as illuminated in detail in FIG. 2. The image may include none, one, two, or multiple eyes from one or multiple persons. The global iris image quality measure (block 12) will decide if the image has sufficient quality for further processing, and/or image quality measure. It also extracts portions of the image for further processing. Here one portion of an image is called a Region of Interest (ROI). Using a ROI can reduce the processing area and improve the efficiency. Each extracted ROI from the global iris image quality measure (block 12) contains a valid eye. The outputs (120) from the global iris image quality measure (block 12) are the global quality score Q and the ROIs. The quality score judgment module (block 13) would check if the quality score from the global quality score is zero. If the global quality score is zero, the image will not be further processed and marked as a poor quality image. If the quality score is non-zero, the quality score judgment module (block 13) will send the ROIs (130) extracted from the global iris image quality measure (block 12) to the preprocessing and quantitative iris image quality measure module (block 15) as illuminated in detail in FIG. 3. The preprocessing and quantitative iris image quality measure module (block 15) will generate an image quality score (a scalar value) and a set of individual image quality metric scores (a quality metric score vector) for each ROI (150). Each ROI is then sent to the iris image segmentation module (block 18). The image gradient method can be used for segmentation. The Segmented ROI is sent to the iris feature extraction and template generation module (Block 16) for further processing. The Gabor wavelet-based iris feature extraction and template generation method in block 16 may be used to perform feature extraction and template generation. The generated iris template from the iris feature extraction and template generation module (block 16) is then used for iris image enrollment, indexing, and matching. The hamming distance-based method can be used for iris matching in the block 17.

The present system in the FIG. 1 may assess the iris quality of an image in real-time and provide an alert to the camera to recapture image if good quality iris is not found.

The present system in FIG. 1 may assess a previously acquired iris image to predict its recognition accuracy and generate recognition accuracy confidence.

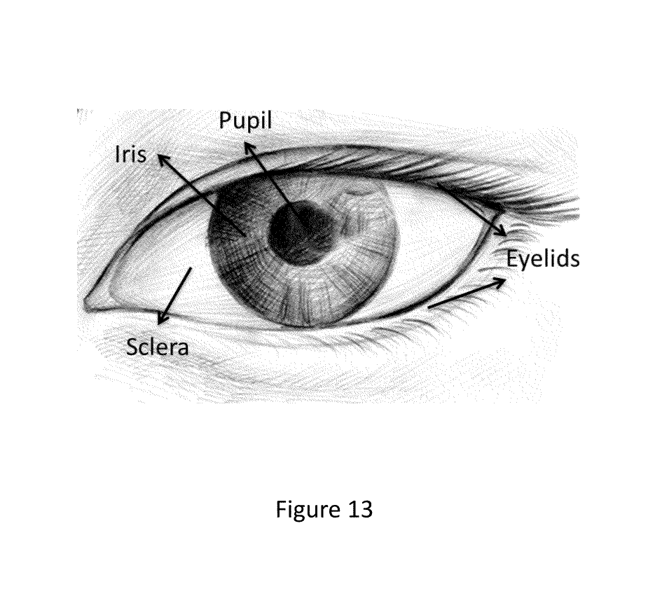

FIG. 2 is a diagram of the global iris image quality measure module 12 of FIG. 1. An image may enter module 12 and go to the illumination and contrast evaluation module (block 21). In module 21, the intensity value histogram distribution and contrast can be used. If the image passes the illumination and contrast assessment (block 22), it will be sent to the blur detection module (block 23). Otherwise, the image quality will be set to 0 and the image will not be sent to further processing. The Cepstrum-based blur detection method can be used. If the image passes the blur assessment (block 24), the image will be sent to the valid eye detection module (block 25). Otherwise, the image quality will be set to 0 and the image will not be sent to further processing. The judgment method depends on the blur assessment method. If the average Euclidean distance is used, the average Euclidean distance needs to be larger than the threshold Td. If the specular size method is used, the specular size should be smaller than the threshold Ts and the lowest specular value should be bigger than the threshold Tv. A valid eye is defined as an open eye. In the valid eye detection module, if the illuminator pattern of the camera is known, searching for the existence of the known specular patterns can be used to determine the existence of a valid eye. If the illuminator pattern is unknown, a window with the estimated valid eye area (based on the image resolution) will be generated to pass through the image to determine if there is a valid eye in the image. A valid eye area (FIG. 13) should include a dark area (pupil area), a gray area (iris area), and a lighter gray or white area (sclera, and/or eyelids). The dark area is surrounded by a gray area, and the gray area is surrounded by a lighter gray or white area. This valid eye pattern can be used to search for the existence of a valid eye. Based on the valid eye pattern detection, the system decides the regions of interest. An image may have none, one, two, or multiple regions of interest. If an image has no region of interest, the image will not pass the valid eye detection judgment module (block 26) and the image quality will be set to 0 and the image will not be sent to further processing. If there is at least one region of interest, each region of interest area is extracted for further processing.

The output of the global iris image quality measure module 12 of FIG. 1 is Q=0, or Q≠0 and ROIs for further processing.

FIG. 3 is a diagram of the preprocessing and quantitative iris image quality measure module 15 of FIG. 1. Each region of interest extracted from the global iris image quality measure module 12 from FIG. 1 may enter the preprocessing and quantitative iris image quality measure module 15 of FIG. 1 and go to the fast and preliminary segmentation module (block 30) to identify the pupil, iris, sclera, specular, and eyelids/eye lashes areas of an eye (FIG. 15). The processed image is then sent to measurement modules such as iris usable area module (block 31), iris size module (block 32), iris-pupil contrast module (block 33), sharpness module (block 34), gray scale spread module (35), pupil shape module (block 36), dilation module (block 37), gaze angle module (block 38), and iris sclera contrast module (block 39). The outputs of these measurement modules are raw data and need to be calibrated for real-life application. Therefore, the outputs from the iris usable area module (block 31), iris size module (block 32), iris-pupil contrast module (block 33), sharpness module (block 34), gray level spread module (block 35), pupil shape module (block 36), dilation module (block 37), gaze angle module (block 38), and iris sclera contrast module (block 39) are sent to the iris usable area calibration module (block 311), iris size calibration module (block 321), iris-pupil contrast calibration module (block 331), sharpness calibration module (block 341), gray scale spread calibration module (351), pupil shape calibration module (block 361), dilation calibration module (block 371), gaze angle calibration module (block 381), and iris sclera contrast calibration module (block 391) respectively to be calibrated. The purpose of the calibration is to ensure the range of each quality metric score is between a preset range (for example, between 0 to 1, or between 0 to 100, or some other range) and the score would be set to properly predict the recognition accuracy. The higher the calibrated score is, the image would more likely to generate a higher recognition accuracy. One method to calibrate a quality metric score is to use large scale training data to plot the relationship between their matching results with their quality metric score. The plotted curve can then be smoothed to be used as a calibration curve. Another method to calibrate a quality metric score is performing theoretical analysis. The set of the scores that are generated from all quality metric calibration modules is called the set of quality metric score, which is a vector. The calibrated measurement outputs of these modules may go to a quality fusion module (block 301). The quality fusion module (block 301) will generate one scalar score to represent the entire region of interest's quality. One method to calculate the overall quality score can be the weighted sum of calibrated quality scores:

Q=Σᵢwᵢfᵢ(qᵢ),

where qᵢ is the quality raw score for quality metric i, fᵢ(·) is the calibration method for the quality metric i, and wᵢ is the weight for the quality metric i. The constraint for the weight is: Σᵢ wᵢ=1, and wᵢ>0, i=1, 2, . . . .

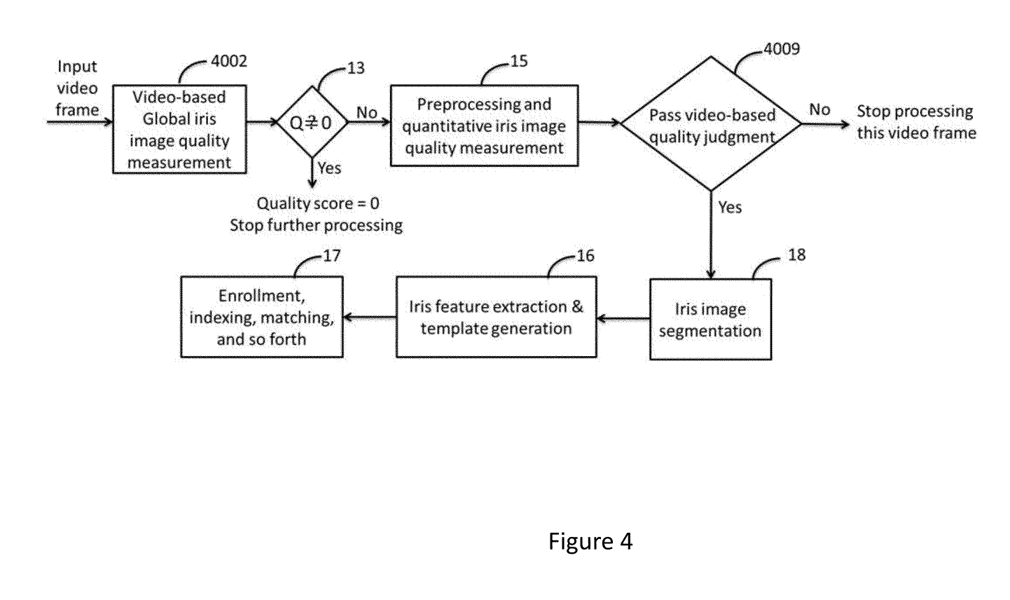

FIG. 4 is a diagram of a video-based iris recognition system incorporating one video-based global iris image quality measure module and one preprocessing and quantitative iris image quality measure module. The iris recognition system in FIG. 1 can be used to process each video frame. However, for a video-based iris recognition system, it is important to take advantage of the correlations between consecutive images/frames to dramatically reduce the processing time. The video-based iris recognition system is designed to serve this purpose.

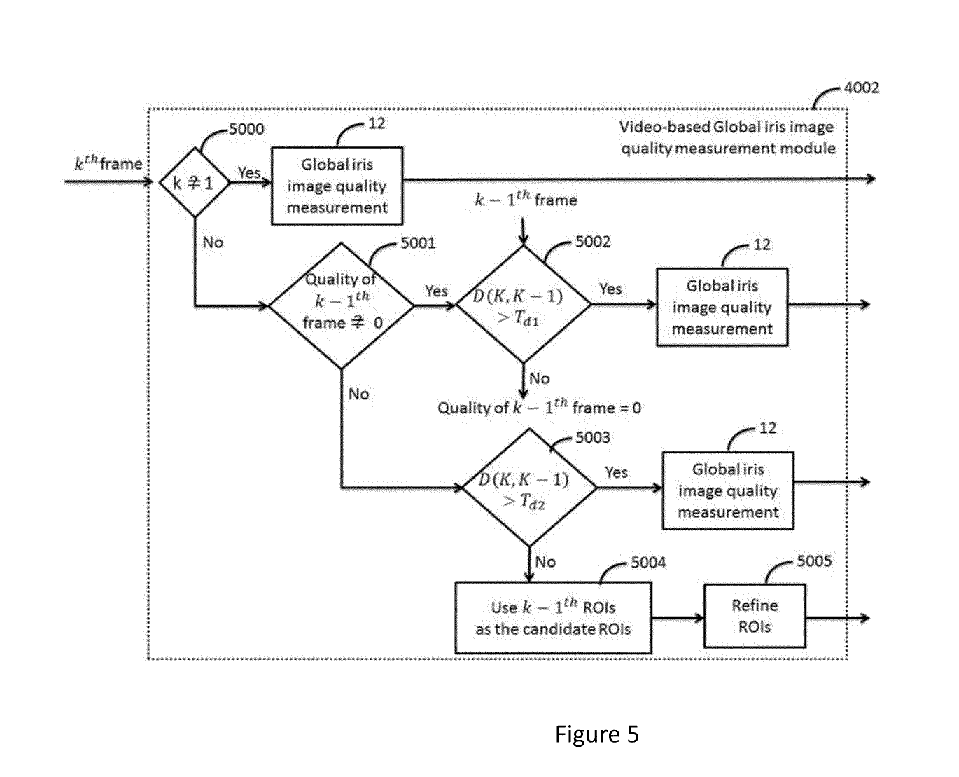

FIG. 4 shows that a video image is sent to the video-based global iris image quality measure (block 4002) as illuminated in detail in FIG. 5. The video-based global iris image quality measure (block 4002) will decide if each image frame needs further processing and/or image quality measure. It also extracts the region(s) of the image that need(s) further processing and/or image quality measure. To reduce the processing time, the video-based global iris image quality measure (block 4002) will use the previous video frame information to process the current frame. If the quality score from the video-based global quality measure is none-zero and passes the quality score judgment (block 4009), the region will directly pass to the preprocessing and quantitative iris image quality measure module (block 15) as illuminated in detail in FIG. 3. Otherwise, the image will not be further processed. The processed image generated from the preprocessing and quantitative iris image quality measure module (block 15) includes a global image quality measure score (a scalar value) and a set of individual image quality metric scores (a quality score vector) for the region. This region quality score is sent to the video-based quality judgment block 4009. If it is higher than the similar region of the previous frame, it is then sent to the iris image segmentation module (block 18). Otherwise, this region is discarded from further processing. The image gradient method can be used to perform segmentation. After segmentation, the iris portion of the image is sent to the iris feature extraction and template generation module (Block 16). The generated iris template from the iris feature extraction and template generation module (block 16) is then used for iris image enrollment, indexing and matching. The hamming distance-based method can be used for iris matching in block 17.

FIG. 5 is a diagram of the video-based global iris image quality measure module 4002 of FIG. 4. It first checks if it is the first frame (block 5000). The first image frame of the video is processed as the global iris image quality measure module 12 of FIG. 1. From the Kth frame (k>1), the system first checks if the image quality of the K−1th frame equals to 0 (block 5001).

If the K−1th frame image quality equals to 0, the system checks if the calculated difference between the K and K−1th frames is larger than threshold Td1 (block 5002). If the difference is larger than Td1, the image frame of the video is processed as the global iris image quality measure module 12 of FIG. 1. If the difference is not larger than Td1, the image quality of this frame will be set to be 0 and the image will not be further processed. This can greatly reduce the processing time since it does not need to process the image to use the modules 21, 22, 23, 24, 25, and 26 in FIG. 2.

If the K−1th frame image quality is not 0, the system checks if the calculated the difference between the K and K−1th frames is larger than threshold Td2 (block 5003). If the difference between K and K−1th frames is larger than Td2, the image frame of the video is processed as the global iris image quality measure module 12 of FIG. 1. If the difference is not larger than Td2, the location of regions of interest that are detected from the K−1th frame will be used in this frame to help identify the candidate regions of interest (block 5004). The system refines the identification of the regions of interest by quickly searching slightly enlarged candidate regions of interest (block 5005). This can greatly reduce the processing time since it does not need to search the entire image to identify possible region of interest.

Note: This design can be altered to work with comparing Kth and K-nth frames, comparing the current frame (Kth frame) with the fusion of several previous frames.

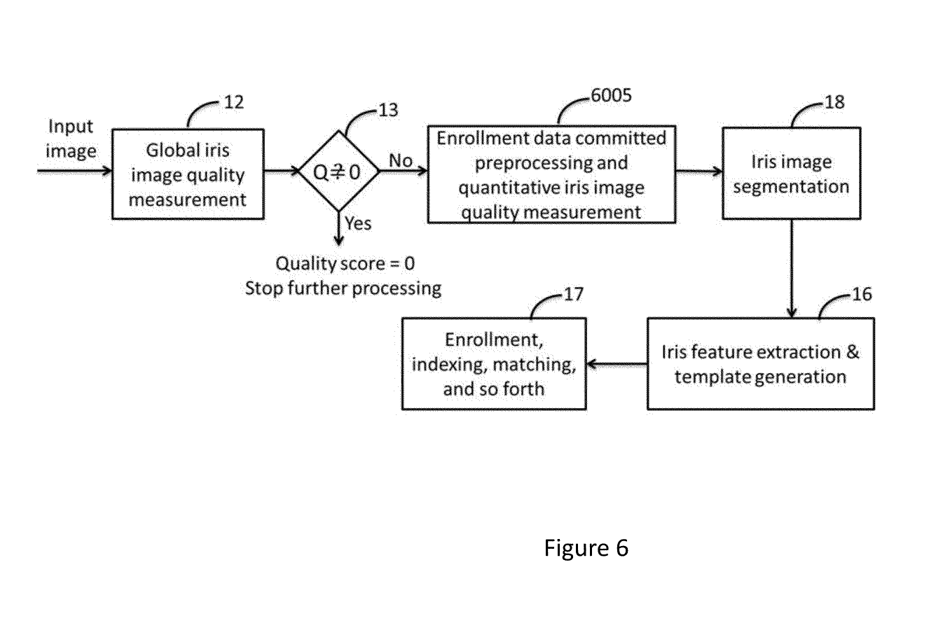

FIG. 6 is a diagram of an enrollment data committed iris recognition system incorporating one global iris image quality measure module and one enrollment data committed preprocessing and quantitative iris image quality measure module. In this scenario, the enrollment data characteristics are known, which include one or more of following characteristics: iris usable area, iris size, iris-pupil contrast, sharpness, pupil shape, dilation, gaze angle, and/or global quality score. The quality score measure in this scenario is not only to analyze the input image's quality characteristics but also to analyze the input and enrolled iris data similarities from a quality point of view to improve the prediction accuracy. The enrollment data can be a raw image or the generated template with quality scores. Or the enrollment data template/raw image can be both unknown but some of their quality characteristics are known. The goal is to use the iris images with proper (acceptable) quality based on the enrollment data characteristics and predict the recognition accuracy between the input image and the enrollment data.

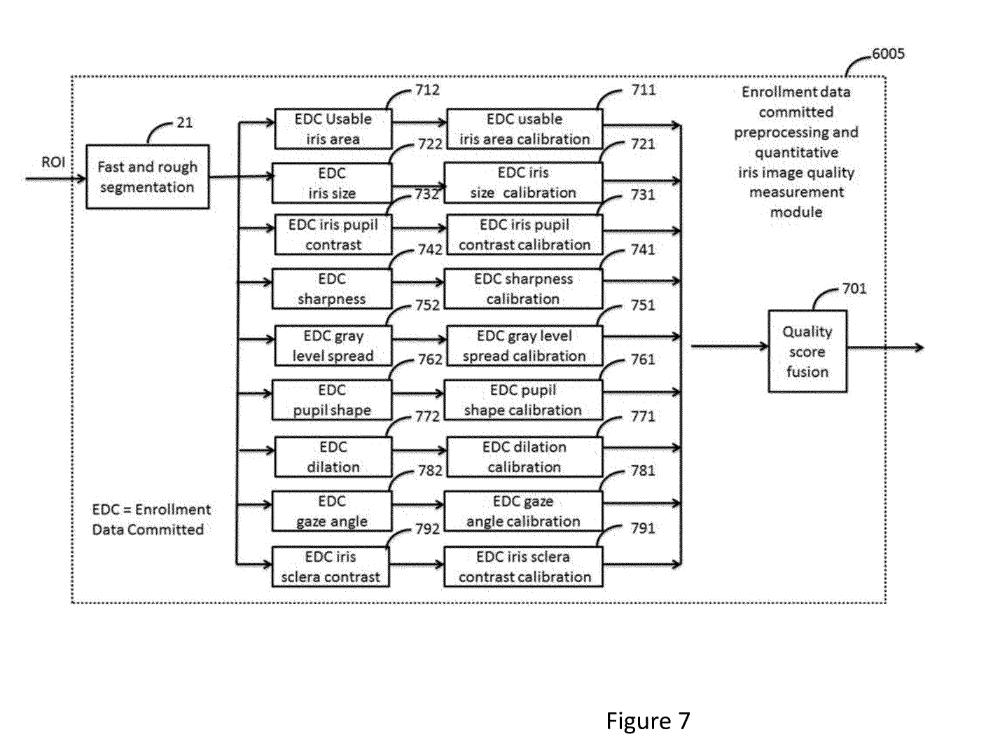

FIG. 6 shows an image sent to the global iris image quality measure (block 12) as illuminated in detail in FIG. 2. The global image quality measure (block 12) identifies region of interests for further processing. If the quality score from the global quality measure is none-zero and passes the quality score judgment (block 13), the region will directly pass to the enrollment data committed preprocessing and quantitative iris image quality measure module (block 6005) as illuminated in detail in FIG. 7. Otherwise, the image will not be further processed. The processed image generated from the enrollment data committed preprocessing and quantitative iris image quality measure module (block 6005) includes a global image quality measure score (a scalar value) and a set of individual image quality metric scores (a quality score vector). This region is sent to the iris image segmentation module (block 18). The image gradient method can be used to perform segmentation. After segmentation, the iris portion of the image is sent to the iris feature extraction and template generation module (Block 16) for further processing. The Gabor wavelet-based iris feature extraction and template generation method in block 16 may be used to perform feature extraction and template generation. The generated iris template from the iris feature extraction and template generation module (block 16) is then used for iris image enrollment, indexing and matching. The hamming distance-based method can be used for iris matching in the block 17.

The present system in the FIG. 6 may assess the iris quality of an image in real-time based on the enrollment data characteristics and provide a warning to the camera to recapture image if a good quality iris is not found.

The present system in FIG. 6 may assess a previously acquired iris image to predict its recognition accuracy and generate recognition accuracy confidence based on the enrollment data characteristics.

The method in FIG. 6 can also be used to select the best input image based on the enrollment data characteristics that would generate high recognition accuracy.

FIG. 7 is a diagram of the enrollment data committed preprocessing and quantitative iris image quality measure module 6005 of FIG. 6. Each region of interest extracted from the global iris image quality measure module 12 from FIG. 6 may enter the enrollment data committed preprocessing and quantitative iris image quality measure module 6005 of FIG. 6 and go to the fast and preliminary segmentation module (block 30) to identify the pupil, iris, sclera, specular, and eyelids/eye lashes areas of an eye (FIG. 13). The processed image is then sent to the enrollment data committed measurement modules such as the enrollment data committed iris usable area module (block 712), the enrollment data committed iris size module (block 722), the enrollment data committed iris-pupil contrast module (block 732), the enrollment data committed sharpness module (block 742), the enrollment data committed pupil shape module (block 762), the enrollment data committed dilation module (block 772), the enrollment data committed gaze angle module (block 782), and the enrollment data committed iris sclera contrast module (block 792).

In the enrollment data committed iris usable area module (block 712), the enrollment data committed usable iris area quality score can be calculated by counting the total percentage of the overlapped valid iris areas of the input image and the enrollment data. In the enrollment data committed iris size module (block 722), the iris size quality score can be calculated as the difference between the iris size and the enrollment iris data size. In the enrollment data committed iris-pupil contrast module (block 732), the iris-pupil contrast quality score can be calculated as the different between the iris pupil contrast of the input image and the enrollment data. In the enrollment data committed sharpness module (block 742), the sharpness quality score can be calculated as the difference between the sharpness between the input data and the enrollment data. In the enrollment data committed gray level spread module (block 752), the gray level spread quality score can be calculated as the difference between the gray level spread between the input data and the enrollment data. In the enrollment data committed pupil shape module (block 762), the pupil shape quality score can be calculated as the difference between the pupil shape between the input data and the enrollment data. In the enrollment data committed dilation module (block 772), the dilation quality score can be calculated as the difference between the dilation of the input data and the enrollment data. In the enrollment data committed gaze angle module (block 782), the gaze angle quality score can be calculated as the difference between the gaze angle of the input data and the enrollment data. And in the enrollment data committed iris sclera contrast module (block 792), the iris sclera contrast quality score can be calculated as the difference between the iris sclera contrast of the input data and the enrollment data.

The outputs of these measurement modules are raw data and need to be calibrated for real-life application. Therefore, the outputs from these modules may be sent to the enrollment data committed iris usable area calibration module (block 711), the enrollment data committed iris size calibration module (block 721), the enrollment data committed iris-pupil contrast calibration module (block 731), the enrollment data committed sharpness calibration module (block 741), the enrollment data committed gray level spread calibration module (block 751), the enrollment data committed pupil shape calibration module (block 761), the enrollment data committed dilation calibration module (block 771), the enrollment data committed gaze angle calibration module (block 781), and/or the enrollment data committed iris sclera contrast calibration module (block 791) respectively to calibrate the quality metric scores. The calibration curve can be obtained by using a large scale training enrollment data and testing enrollment data to generate their relationships.

The purpose of the enrollment data committed calibration is to ensure the range of each quality metric score is in the preset range (such as between 0 to 1, or between 0 to 100, etc.). The set of the scores that are generated from all the enrollment data committed quality metric calibration modules is the set of quality metric scores, which is a vector.

The calibrated measurement outputs of these enrollment data committed modules may go to an enrollment data committed quality fusion module (block 701). The enrollment data committed quality fusion module (block 701) will generate one scalar score to represent the entire region of interest's quality based on the enrollment data characteristics. One method to calculate the overall quality score can be the weighted sum of the enrollment data committed calibrated quality scores.

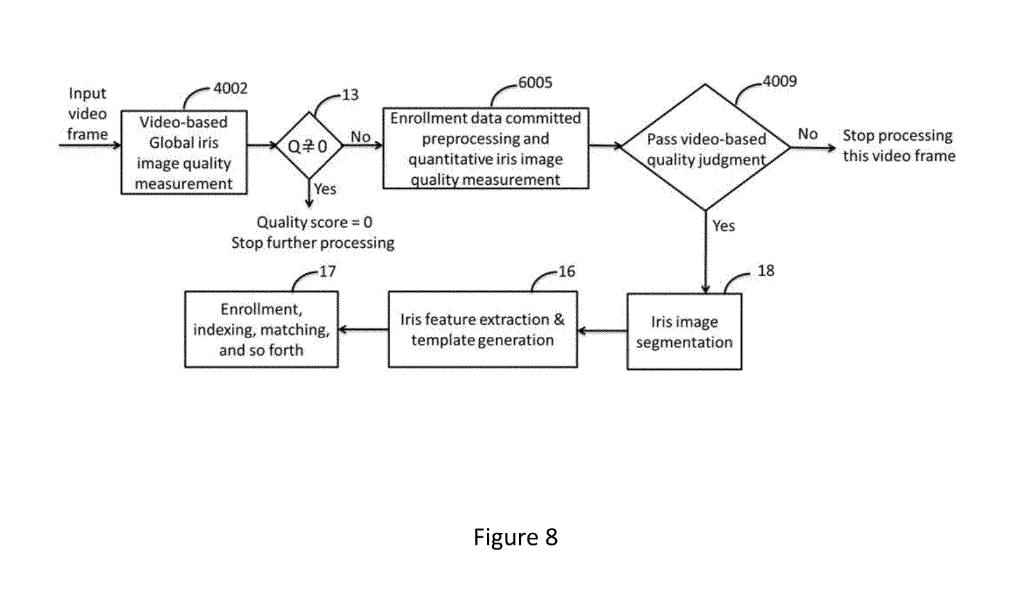

FIG. 8 is a diagram of an enrollment data committed video-based iris recognition system incorporating one video-based global iris image quality measure module and one enrollment data committed video-based preprocessing and quantitative iris image quality measure module.

The individual image-based enrollment data committed iris recognition system (FIG. 6) can be used to process each video frame. However, for a video-based iris recognition system, it is important to take advantage of the correlations between consecutive images/frames to dramatically reduce the processing time. The video-based enrollment data committed iris recognition system is designed to serve this purpose.

FIG. 8 shows a video image sent to the video-based global iris image quality measure (block 4002) as illuminated in detail in FIG. 5. The video-based global iris image quality measure (block 4002) will decide if the each image frame needs further processing and/or image quality measure. If the quality score from the video-based global quality measure is none-zero and passes the quality score judgment (block 4003), the region will directly pass to the enrollment data committed preprocessing and quantitative iris image quality measure module (block 6005) as illuminated in detail in FIG. 7. Otherwise, the image will not be further processed. The processed image generated from the enrollment data committed preprocessing and quantitative iris image quality measure module (block 6005) includes a global enrollment data committed image quality measure score (a scalar value) and a set of individual enrollment data committed image quality metric scores (a quality score vector). This region quality score is sent to the quality judgment block 4009. If it is higher than the similar region of the previous frame, it is then sent to the iris image segmentation module (block 18). Otherwise, this region is discarded from further processing. The image gradient method can be used to perform segmentation. After segmentation, the iris portion of the image is sent to the iris feature extraction and template generation module (Block 16) for further processing. The generated iris template from the iris feature extraction and template generation module (block 16) is then used for iris image enrollment, indexing and matching (block 17).

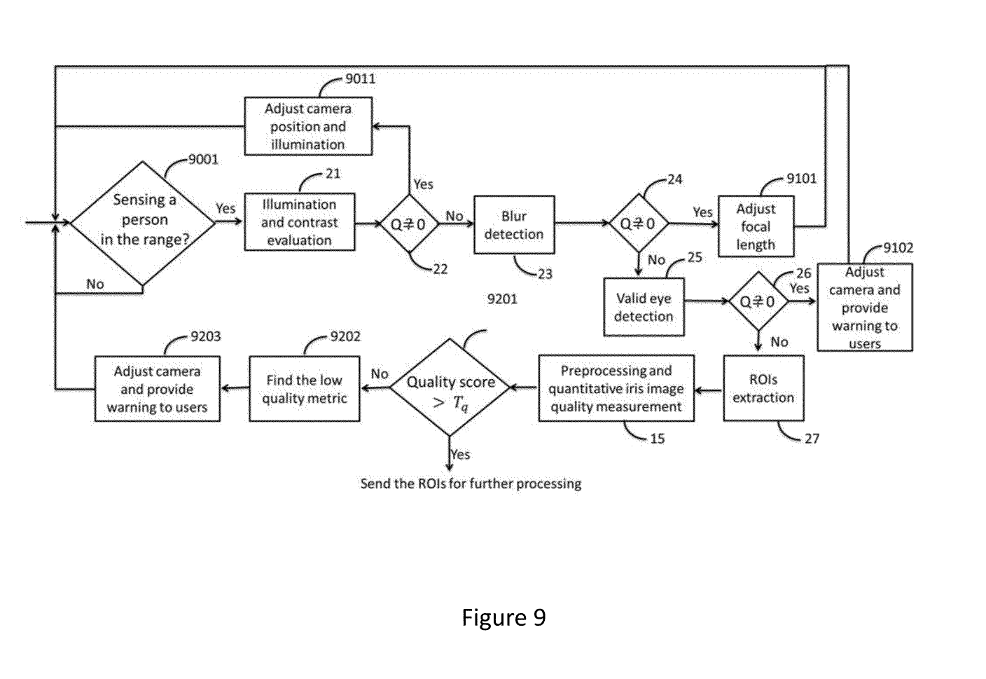

FIG. 9 is a diagram of an iris image quality assurance camera that incorporates a two-stage iris image quality measure. Incorporating the two-stage iris image quality measure into the camera design can help the system to actively search for high quality images and reduce image acquisition time, failure to acquire rate, false rejection rate, and false acceptance rate. That is, it can increase the recognition accuracy while increasing the iris recognition usability.

FIG. 9 shows the camera first sense if a person is in the range of acquisition distance (Block 9001). The sensing method can be an infrared sensor that senses the presence of a human by searching for a temperature within a given range. If a person is in the range, it would begin to acquire video images. The acquired video would go to the illumination and contrast evaluation module (block 21). In module 21, the maximum intensity value Mₓ and minimum intensity value Mᵢ are calculated from the image. If the image does not pass the illumination and contrast assessment (block 22), the camera would adjust its illumination and position (block 9011). If the image passes the illumination and contrast assessment (block 22), it will be sent to the blur detection module (block 23). Since the illuminator pattern of the camera is known, the specular of an image can be used to evaluate if it is blurry. A blur image would have larger specular area with weaker specular. If the image does not pass the blur assessment (block 24), the camera would check if the specular reflection has low intensity (block 9101).

If the image passes the blur detection module (block 24), the camera would search for the regions of interest that contain valid eyes (block 25). Since the illuminator pattern of the camera is known, searching of the existence for the known specular patterns can be used to determine the existence of a valid eye. Then the system would check if Q=0 (block 26).

If an image does not have a valid eye (i.e. Q=0), the camera would change its position or provide feedback to users and ask the user to look at the camera (9102).

If an image has region(s) of interest, the region(s) will be extracted (block 27) and passed to the preprocessing and quantitative iris image quality measurement module (block 15). The camera checks if the quality score is lower than the expected value (block 9201). If it is lower, it would find a low quality metric (block 9202). The camera would then perform the proper adjustment and/or provide warning message to the user for cooperation (block 9203).

Some sample approaches are described below. The system would check if the iris usable area score is low. If the iris usable area score is low, the system would ask user to open his/her eyes and/or delay the shutter time. If the iris size score is low, the system would ask the user to adjust his/her distance to the camera and/or increase the image resolution. If the iris-pupil contrast score is low, the system would check if pupil area is dark. If the pupil area is dark, the system would increase illumination strengths. If the pupil area is too bright, the system would ask the user to move their head to avoid strong reflectance from environmental light and/or adjust the camera aperture. If the sharpness score is low, the system would ask the user to move their head to avoid strong reflectance from environmental light and/or increase the image acquisition speed. If the pupil shape score is low, the system would ask the user to look at the camera. If the dilation score is low, the camera would adjust the illumination strength. If the gaze angle score is low, the camera would ask the user to look at the camera.

If the overall acquisition process has been over certain time limit and it has not acquired a satisfactory image, the camera would provide warning to operator and ask if another image acquisition is necessary.

FIG. 10 is a diagram of a video-based iris recognition system incorporating the iris image quality assurance camera (block 1001). The iris image quality assurance camera (block 1001) outputs the regions of interest. Each region of interest contains a high quality iris. The region is then processed by the segmentation module (18). The image gradient method can be used to perform segmentation. After segmentation, the iris portion of the image is sent to the iris feature extraction and template generation module (Block 16) for further processing. The generated iris template from the iris feature extraction and template generation module (block 16) is then used for iris image enrollment, indexing and matching (block 17).

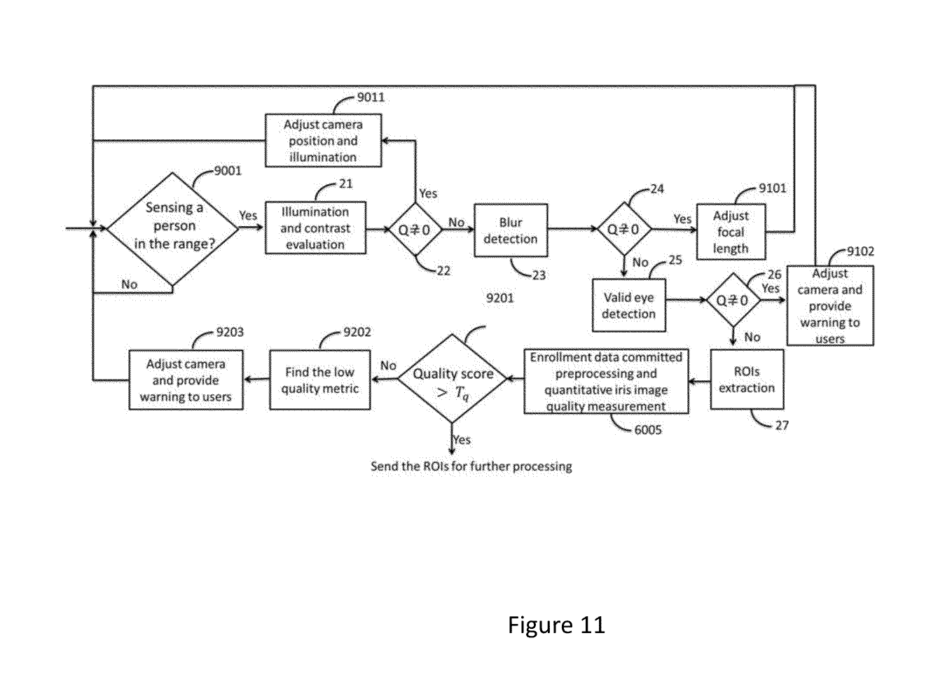

FIG. 11 is a diagram of an enrollment data committed iris image quality assurance camera that incorporates the enrollment data committed iris image quality measure.

FIG. 11 shows the camera first senses if a person is in the range of acquisition distance (Block 9001). If a person is in the range, it would begin to acquire video images. The acquired video would go to the illumination and contrast evaluation module (block 21). If the image does not pass the illumination and contrast assessment (block 22), the camera would adjust its illumination and reposition (block 9011).

If the image passes the illumination and contrast assessment (block 22), it will be sent to the blur detection module (block 23). Since the illuminator pattern of the camera is known, the specular of an image can be used to evaluate if it is blurry. A blur image would have larger specular area with weaker specular. If the image does not pass the blur assessment (block 24), the camera would check if the specular reflection has low intensity (block 9101).

If the image passes the blur detection module (block 24), the camera would search for the regions of interest that contain a valid eye (block 25). Since the illuminator pattern of the camera is known, searching of the existence of the known specular patterns can be used to determine the existence of a valid eye.

If an image does not have a valid eye, the camera would change its position or provide feedback to users and ask the user to look at the camera.

If an image has region(s) of interest, the regions will be passed to the enrollment data committed preprocessing and quantitative iris image quality measurement module (block 6005). The camera checks if the quality score is lower than the expected value (block 9201). If it is lower, it would go to the low quality metric (block 9202). The camera would then perform proper adjustment and/or provide a warning message to the user for cooperation (block 9203).

If the overall acquisition process exceeded a certain time limit and it has not acquired a satisfactory image, the camera would provide a warning to the operator and ask if another image acquisition is necessary.

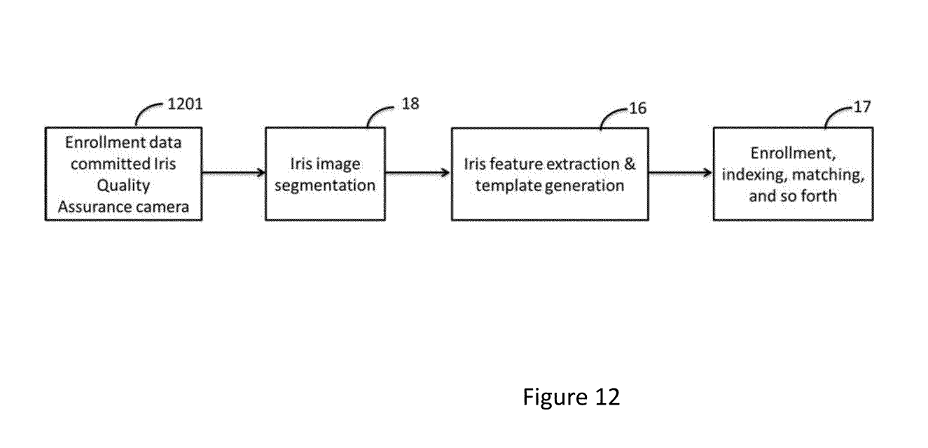

FIG. 12 is a diagram of a video-based iris recognition system incorporating the enrollment data committed iris image quality assurance camera (block 1201) as illuminated in detail in FIG. 11. The enrollment data committed iris image quality assurance camera (block 1201) outputs the regions of interest. Each region of interest contains a high quality iris. The region is then processed by the segmentation module (18). The image gradient method can be used to perform segmentation. After segmentation, the iris portion of the image is sent to the iris feature extraction and template generation module (Block 16) for further processing. The generated iris template from the iris feature extraction and template generation module (block 16) is then used for iris image enrollment, indexing, and matching (block 17).

Those skilled in the art will recognize that numerous modifications can be made to the specific implementations described above. Therefore, the following claims are not to be limited to the specific embodiments illustrated and described above. The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A two-stage iris image quality assessment method comprising:
a global image quality assessment; and
a preprocessing and qualitative iris image quality assessment;
wherein the global image quality assessment module decides if the entire image has sufficient quality for further processing;
wherein the global image quality assessment module detects the regions of interest (ROIs);
wherein the global image quality assessment module extracts the regions of interest (ROIs) that each region of interest contains a valid eye based on the automatic judgment for further processing;
wherein the preprocessing and qualitative iris image quality assessment would evaluate the iris image quality of each ROI;
wherein the preprocessing and qualitative iris image quality assessment would provide a global quality score and/or a set of quality metric scores for each ROI;
wherein the quality metric scores of each ROI are calibrated if quality metric scores are provided; and
wherein the overall quality score of each ROI is a fusion of the quality metric scores.

2. The method of claim 1, wherein the global image quality assessment module further includes an analysis of one or more of the following image conditions which comprise:
illumination and contrast evaluation;
blur valuation; and/or
valid eye detection.

3. The method of claim 1, wherein the preprocessing and qualitative iris image quality assessment further includes a quantitative analysis of one or more of the following image conditions which comprise:
usable iris area and its calibration method;
iris size and its calibration method;
iris-pupil contrast and its calibration method;
sharpness and its calibration method;
pupil shape and its calibration method;
gray-scale spread and its calibration method;
iris sclera contrast and its calibration method;
dilation and its calibration method; and/or
gaze angle and its calibration method.

4. The method of claim 3, wherein the calculation of each quality score calculation and calibration can be turned on and off; and wherein the fusion method can be adjusted based on which quality score metric score calculation is turned on.

5. The method of claim 1, wherein the global iris image quality assessment module can work with an image with none, one, two, or multiple valid eyes from one or multiple people; and wherein the output of this module can be the entire image (i.e. the image is kept as one ROI) for further processing.

6. A two-stage iris video image quality assessment method comprising:
a global iris video image quality assessment; and
a preprocessing and qualitative iris image quality assessment;
wherein the global iris video image quality assessment module decides if the image has sufficient quality for further process;
wherein the global iris video image quality assessment module detects the regions of interest by taking advantage of the correlation between consecutive video frames to reduce the processing time;
wherein the preprocessing and qualitative iris image quality assessment would provide an overall quality score and/or a set of quality metric scores;
wherein the quality metric scores are calibrated if quality metric scores are provided; and
wherein the overall quality score is a fusion of the quality metric scores.

7. The method of claim 6, wherein the global video image quality assessment module further includes a video-based analysis of one or more of the following image conditions which comprise:
illumination and contrast evaluation;
blur valuation; and/or
valid eye detection.

8. The method of claim 6, wherein the global iris image quality assessment module can work with a video with none, one, two, or multiple valid eyes from one or multiple people; wherein this module can work with a video image that contains a varied number of valid eyes valid eyes from different people in different video frames; and
wherein the output of this module can be the entire image frame (i.e. the image is kept as one ROI) for further processing.

9. An enrollment data committed iris image quality assessment method comprising:
a global iris image quality assessment; and
an enrollment data committed preprocessing and qualitative iris image quality assessment;
wherein the enrollment data committed preprocessing and qualitative iris image quality assessment module would evaluate the iris image quality based on both the input image and enrollment data characteristics;
wherein the enrollment data committed preprocessing and qualitative iris image quality assessment would provide an overall enrollment data committed quality score and/or a set of enrollment data committed quality metric scores by incorporating the comparison between the enrolled iris data quality and the input data quality;
wherein the quality metric scores are calibrated if quality metric scores are provided; and
wherein the overall quality score is a fusion of the quality metric scores.

10. The method of claim 9, wherein the enrollment data committed preprocessing and qualitative iris image quality assessment module provides an overall enrollment data committed quality score and/or a set of enrollment data committed quality metric scores by incorporating the comparison between the enrolled iris data quality and the input data quality.

11. The method of claim 9, wherein the enrollment data committed preprocessing and qualitative iris image quality assessment module would perform regular image quality metric score calculation/calibration for some quality metrics if these quality metric characteristics of the enrollment data is unknown while performing enrollment data committed quality metric score calculation/calibration for the rest of the quality metrics if these quality metric characteristics of the enrollment data is known.

12. An enrollment data committed video-based iris image quality assessment method comprising:
a global iris video image quality assessment; and
an enrollment data committed preprocessing and qualitative iris image quality assessment;
wherein the global video image quality assessment module decides if the image has sufficient quality for further processing;
wherein the global video image quality assessment module detects the regions of interest by taking advantage of the correlation between consecutive video frames to reduce the processing time; and
wherein the enrollment data committed preprocessing and qualitative iris image quality assessment would
provide a global enrollment data committed quality score and a set of enrollment data committed quality metric scores by incorporating the comparison between the enrolled iris data quality and the input data quality.

13. An iris image quality assurance camera system, comprising:
a global image quality assessment;
a preprocessing and qualitative iris image quality assessment; and
camera adjustment and alert message methods to the user and/or operator based on the global image quality assessment results and/or qualitative iris image quality assessment results;
wherein the global image quality assessment module decides if the entire image has sufficient quality for further processing and detects the regions of interest (ROIs);
wherein each region of interest contains a valid eye for further processing;
wherein the preprocessing and qualitative iris image quality assessment would provide a global quality score and a set of quality metric scores for each ROI.

14. The system of claim 13, wherein the camera adjustment methods include one or more of following components:
illumination adjustment;
shutter adjustment;
camera aperture adjustment;
image acquisition frame rate adjustment;
focus adjustment; and/or
position adjustment.

15. An enrollment data committed iris image quality assurance camera system, comprising:
a global image quality assessment;
an enrollment data committed preprocessing and qualitative iris image quality assessment; and
camera adjustment and alerting methods to the user and/or operator based on the global image quality assessment results and/or qualitative iris image quality assessment results;
wherein the global image quality assessment module decides if the entire image has sufficient quality for further processing and detects the regions of interest (ROIs);
wherein each region of interest contains a valid eye for further processing; and
wherein the preprocessing and qualitative iris image quality assessment would evaluate the iris image quality of each ROI;
wherein the preprocessing and qualitative iris image quality assessment would provide an overall quality score and/or a set of quality metric scores for each ROI.

16. The system of claim 15, wherein the camera adjustment methods include one or more of following components:
illumination adjustment;
shutter adjustment;
camera aperture adjustment;
image acquisition frame rate adjustment;
focus adjustment; and/or
position adjustment.

17. The method of claim 1, wherein the two stage iris image quality assessment method can be integrated into an iris recognition system comprising:
an iris image acquisition camera;
a global image quality assessment;
a preprocessing and qualitative iris image quality assessment;
a segmentation method;
a feature extraction and template generation method;
an iris enrollment method;
an iris matching method; and
a database of iris templates.

18. The method of claim 6, wherein the two stage iris video image quality assessment method can be integrated into an iris video-based recognition system, comprising:
an iris video camera;
an global iris video image quality assessment;
a preprocessing and qualitative iris image quality assessment;
a segmentation method;
a feature extraction and template generation method;
an iris enrollment method;
an iris matching method; and
a database of iris templates.

19. The method of claim 9, wherein the enrollment data committed iris image quality assessment method that can be integrated into an enrollment data committed iris recognition system, comprising:
an iris camera;
a global iris image quality assessment;
a preprocessing and qualitative iris image quality assessment;
a segmentation method;
a feature extraction and template generation method;
an iris enrollment method;
an iris matching method; and
a database of iris templates; and
an enrollment data committed preprocessing and qualitative iris image quality assessment.

20. The method of claim 12, wherein the enrollment data committed iris video image quality assessment method can be integrated into an enrollment data committed video-based iris recognition system, comprising:
an iris video camera;
a video-based global iris image quality assessment;
an enrollment data committed preprocessing and qualitative iris image quality assessment;
a segmentation method;
a feature extraction and template generation method;
an iris enrollment method;
an iris matching method; and
a database of iris templates.
